(19) United States
(12) Patent Application Publication
(10) Pub. No.: US 2012/0124099 A1
(43) Pub. Date: May 17, 2012

(54) Expert system for subject pool selection

(75) Inventor: Lisa Ellen Stewart, Cambridge, MA (US)

(73) Assignee: Lisa Ellen Stewart, Cambridge, MA (US)

(21) Appl. No.: 12/927,302

(22) Filed: Nov. 12, 2010

(51) Int. Cl. G06F 17/30

(52) U.S. Cl. 707/802; 707/E17.044

(57) ABSTRACT

This invention is a method directed to the recruitment and assembly of groups that are characteristic of selected populations, specifically to the identification of representative subject pools that satisfy the disparate statistical and data security needs of diverse disciplines.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

### Technical Field

This invention is directed to the assembly of groups that are characteristic of selected populations, specifically to the identification of representative subject pools that satisfy the particular statistical and data security needs of diverse disciplines.

Quality research requires quality data sources. Selection of a subject pool, a group of individuals that has compositional characteristics substantially representative of a population of interest, is an important step in research planning and can be both complex and difficult. Subject pool choice can be economically significant because an unrepresentative subject pool can be a waste of resources for not producing useful results. For ethical reasons because an unrepresentative subject pool can expose human or animal subjects to potentially harmful treatments without advancing knowledge. And for scientific reasons because an unrepresentative subject pool selection can lead to misleading results and erroneous conclusions.

Several factors are important in the recruitment and selection of individuals for subject pool inclusion: 1) identification of a pool of individuals with baseline characteristics common to the population of interest; 2) use of appropriate sample size and sampling method(s) for the selection of a representative subject pool; 3) identification and consideration of sources of variation associated with the pool; and 4) in the case of human subjects, for ethical considerations of ensuring informed consent, undue inducement, and maintaining personal privacy and confidentiality of individuals.

Underlying these factors are three key requirements: obtaining individual-specific data with adequate detail and scope, effective sampling, and data security.

### Individual-Specific Data Detail and Scope

In order to provide individual-specific data sufficient in detail and scope for the selection of multiple subject pools of diverse disciplines, prior art methods anticipate that an enormous volume of data be collected for each individual in a centralized source.

U.S. patent 20050210015 to Zhou, Xiang Sean et al. (2005); and U.S. patent 20050256380 to Nourie, Michael et al. (2005) disclose methods for obtaining patient data from multiple, distributed data sources. These methods include requirements that the data be converted to a common, standardized format; be individual-specific; defined for a single well-defined, specific field of study; and/or collected prior to the patient selection process.

That is, prior art uses patient information sources and is substantially constrained to pre-determined and pre-processed data that is specific to the medical field.

U.S. Pat. No. 7,177,822 to Mahmood, et al. (2007) disclose methods for compiling marketing data from multiple data sources into a centralized database and distributing subsets of the compiled data to multiple client venues using an extract engine. However, it does not provide a method for linking specific records with uniquely associated data obtained from disparate data sources. Further, its application is limited to the sales and marketing fields.

### Effective Sampling

Sampling refers to choosing a subset of individuals that represent a target population. It is essential for effective subject pool formation since testing an entire population to answer a specific question is typically cost prohibitive in terms of time, money, and resources. Many different data sampling methods exist with varying degrees of sophistication and complexity. The use of appropriate sampling methods is essential for the selection of individuals that together have the necessary group composition. That is, subject pools with similar proportions of characteristics as the population of interest. Example: a group consisting of 40% males & 60% females whose ages range from 18 to 78 years with a mean of 34 years old.

Effective sampling also requires that the subject pool size accommodates the needs of a study. Subject pool size is important because an under-sized study can be a waste of resources for not producing useful results and an over-sized study uses more resources than necessary. Statistical significance varies with the number and type of characteristics used to describe the population as well as the variables being tested. Further, different disciplines have diverse threshold criteria for what are considered statistically significant results.

Choosing the appropriate sampling method and parameters in order to identify suitably sized subject pools which are adequately representative of the target populations further varies with the specific purpose of a given study. For example, pilot studies typically need only a few subjects and are aimed at obtaining baseline information, ensuring that test equipment is functioning properly, subjects can understand the task instructions, etc. Consequently, simple random selection methods of qualified participants may be sufficient. However, for a large expensive study of an extensive and heterogeneous population, one or more sampling methods may be required to identify the most cost effective, adequately sized, and representative subject pool.

U.S. patent 20040236601 to Summers, Mark et al. (2004); U.S. Patent 20050210015 to Zhou, Xiang Sean et al. (2005); U.S. parent 20050256380 to Nourie, Michael et al. (2005); and Int'l patent JP2008186039 to Masafumi et al (2008) disclose methods for clinical trial recruitment and identification of patients. However, they do not address the important and complex task of sampling for adequately sized and representative subject pools. Further, these methods are limited to the recruitment of subjects for clinical trials.

### Data Security

Data security relies on two factors: computer security and privacy protection. With the rapid advancement of technology and increasingly data rich environment, the conventional methods used to safeguard data security and taken for granted in prior art methods are rapidly becoming outmoded and significantly diminished in their effectiveness.

Cybercrime, such as identity theft, on networked systems has become exponentially prevalent in recent years. Consequently, measures traditionally associated with computer security, such as access control and authentication, quickly become outdated and inadequate.

Privacy protection requires that anonymity of sensitive data is maintained. Until very recently, data with explicit identifiers such as name, address, and phone number removed has generally been deemed “de-identified” and thus anonymous. However, as with computer security, the reliability of this assumption is eroding. It has been clearly evidenced that simply removing explicit identifiers is not sufficient for maintaining anonymity. As pointed out in a seminal study by Sweeney, 87% of the US population can be uniquely identified using just gender, birth date, and zip code. The implications of this are immense and illustrate that the more individual-specific data is contained in a given dataset, the greater the risk to personal privacy—whether de-identified data is acquired legitimately or not.

### Summary of Prior Art

Web based systems such as http://www.sona-systems.com and http://researchmatch.org as well as the prior art patents discussed above have offered solutions to identifying and selecting individual subjects for the needs of clinical trials and marketing. However, they neglect to address the complex and important compositional issues essential for the effective selection of subject pools which are representative of the target populations. Further, prior art methods are constrained to predetermined data sources and structures, are designed for the specific disciplines of clinical trials and marketing, and do not address current or emerging data security issues. Consequently, prior art subject selection methods are insufficient for the increasingly complex economic, ethical, and scientific needs of emerging research requirements and rigor.

### OTHER REFERENCES

Ali, Z and Singh V. (2010), Potentials of Fuzzy Logic: An Approach to Handle Imprecise Data, International Journal of Engineering Science and Technology, Vol. 2(4), 358-361.
Dwork, C (2008), Differential Privacy: A Survey of Results, LNCS, Springer-Verlag Berlin Heidelerg. Vol. 4978, 1-19.
Lenth, R. R. (2001), Some Practical Guidelines for Effective Sample-Size Determination, The American Statistician, Vol. 55, 187-193.
Sears, D. O. (1986), College Sophomores in the Laboratory: Influences of a Narrow Database on Social Psychology's View of Human Nature, Journal of Personality and Social Psychology, Vol. 51, No. 3, 515-530.
Sweeney, L. (2002), K-anonymity: A model for Protecting Privacy, International Journal of Uncertainty, Fuzziness and Knowledge-based Systems, Vol. 10(5), 557-570.

### BRIEF SUMMARY OF THE INVENTION

This invention is an adaptable system for optimal sampling and selection of representative groups, such as subject pools, which effectively characterize populations of interest. Further, it flexibly accommodates the diverse statistical and data security requirements of multiple disciplines. And it allows for the identification and control of variation sources associated with specific group compositions.

### Objects and Advantages

Accordingly, several objects and advantages of the present invention are to provide an expert system for subject pool selection that:

For system users, provides means to
a) query system-specific data as well as detailed data and metadata from external sources;
b) identify well characterized individuals with common selection characteristics;
c) sample qualified individuals for inclusion in optimally sized subject pools;
d) sample qualified individuals for inclusion in subject pools which are representative of populations of interest;
e) track individual subject participation and compensation;
f) identify and control subject pool related sources of research result variation;
g) address current and emerging data security issues.

For groups composed of human subjects,
h) provides easy access to multiple and wide ranging study participation opportunities;
i) requires minimal individual-specific information disclosure;
j) reduces risks to personal privacy and confidentiality;
k) reduces risks of unnecessary exposure to potentially harmful treatments;
l) provides for informed consent;
m) decreases the likelihood of undue inducement.

Further objects and advantages of this invention will become apparent from a consideration of the drawings and ensuing description.

### BRIEF DESCRIPTION OF THE SEVERAL VIEWS OF THE DRAWING

FIG. 1 Shows a preferred system data structure and security.

FIG. 2 Shows a preferred system operation for the selection of a human subject pool.

FIG. 3 Shows a preferred system operation for the selection of a non-human subject pool.

### DETAILED DESCRIPTION OF THE INVENTION

The following terms and labels are used in the description and drawings of the invention, referred to here as the system:

### Agents: User, Individual, Administrator

User refers to the agent listing a study and making subject pool selection choices. Individual refers to the singular entity or agent (e.g. person, patient, animal, object, etc.) to be considered for inclusion in a subject pool. Administrator refers to a super user who maintains and updates the system.

### Secure Data Transmission, Storage, and Access

Secure data transmission refers to the protected movement of data between local system and remote devices.

Secure data storage refers to the use of protected devices and security techniques to cache information that is generated and/or used by the system.

Transmission and storage security techniques can include but are not limited to encryption methods, coded data, secure information flow techniques, and k-anonymity protection.

Secure data access refers to methods which restrict data access based on who the agent is and what the agent needs are. These methods can include but are not limited to multi-level database and differential privacy techniques.

### Definitions of Data Sources

Data input and access may be obtained from or by multiple networked resources using but not limited to client-server, peer-to-peer, and cloud computing.

Data structures can include but are not limited to flat-file, hierarchical, relational, and object-oriented. Data types may include but are not limited to human language text, geographic information, image, audio, structured, unstructured, metadata, and audio classifications.

Agents may input system data using secure transfer methods that can include but are not limited to web forms, file transfers, and script calls to remote databases.

D-1) Study-specific data. Includes subject pool qualification criteria; selected characteristics used to define the population of interest; sampling criteria; criteria matching thresholds; information about the purposes, risks, benefits, confidentiality protections, and other relevant aspects of the study itself; individual-specific data uniquely associated with a study; results of subject pool qualification and selection process; and tracking data of subject participation and compensation status.
D-2) Individual-specific data. Includes information characteristic of each individual such as year of birth, gender, educational attainment, zip code, IP address, etc. This data is used to qualify individuals who meet study-specific criteria, sample qualified individuals, select subject pools, and identify sources of subject pool related study result variation.
D-3) Linkage-specific data. Includes reference data used to relate local and remote data sources with study- and individual-specific data. Linkage-specific data may include URL, IP address, data structure, field descriptions, data dictionary, and other information necessary to access, associate, and/or directly link individual-specific and study-specific records with other data sources.

Linkage-specific data may also include privacy related information such as specific k-anonymity and differential privacy procedures, criteria, and thresholds selectively associated with a given data source. This linkage information allows agents the ability to obtain information of sufficient accuracy and detail while maintaining appropriate levels data security; including privacy and confidentiality of individual-specific information.

D-4) Other data. Refers to data sources that may reside on remote devices and can be accessed by methods such as bulk downloads or script calls to networked databases.
D-5) Metadata. Refers to data about data that may exist on the local system or obtained from remote data sources. Techniques used to obtain metadata and familiar to those skilled in the art are data mining (DM) and information extraction (IE). Data mining refers to the process of extracting patterns from data. Information extraction refers to the process of extracting structured information from unstructured machine-readable documents such as human language texts.

Metadata may be used in tasks such as characterizing study-specific populations of interest, subject pools, pool sub-groups, and/or individuals.

### Example 1

If the population of interest is the city of Chicago, data from a remote device containing information about voter registration and election results in Chicago may be used to obtain metadata about the characteristic political make-up of the city. This metadata may then be used to specify the proportion of liberal vs. conservative voters included in a subject pool representative of that city.

### Example 2

To identify a pool of individuals with high online “social power”, metadata describing the distribution of a measure of centrality such as “betweeness”, “closeness”, or “degree” may be obtained from a social network data source. This metadata may then be used to define an appropriate centrality threshold used to qualify the desired individuals.

### Record Identifier Types

The following record identifier types, familiar to those skilled in the art, are recited for the sake of clarity. In this description, the terms join and link are synonymous.

R-1) Unique identifiers refer to field values that are uniquely associated with a record in a data table. Using unique ID values, individual records from two or more data tables may be linked one-to-one. For example, a table containing individual records with sports membership information can be joined with a table containing individual records with marital status information using the unique identifier field values in each table for a one-to-one join of individual records.
R-2) Specific identifiers refer to data field values that are common to one or more records in one or more data tables. Using a specific ID values, data records may be linked one-to-many, many-to-one, or many-to-many. For example, a table containing records of individual-specific contact information may contain records of multiple individuals who share the same postal code. A census table may contain postal code-specific records each of which holds relevant demographic information for that postal area. The two tables may be linked many-to-one using the postal code.
R-3) Quasi identifiers refer to a subset of record attributes that can distinguish almost all record attributes and be linked with a data source. For example, individual-specific records may contain gender, birth year, and postal code fields. Records for a marketing survey may also contain gender, birth year, and postal code information. In this case these three attributes, or quasi identifiers, may be used to link most individual-specific data with the relevant marketing survey data.

Data associations can be made using any of these three types of identifiers to join specific system records (D-1, D-2, D-3, & D-5) with other data (D-4).

Data associations may also be made by linking specific records with metadata from other data sources that specifically or generally relate to individual records. For example, summary income distributions associated with people of specific ages and educational levels. This data, calculated using information from other data sources (D-4), can be joined with individual-specific records using quasi-identifiers or individual data field values.

### Selection Methods

These can include but are not limited to boolean, fuzzy, and probabilistic logic as well as machine learning algorithms.

Selection methods may also include the application of group composition criteria such as those identified using group process theories, psychographic measures, or demographic profiles.

### Examples

To identify individuals who are right handed, simple boolean logic may be used. To identify individuals who are probably going to vote for an Independent candidate in the next election, fuzzy logic may be used. To identify individuals who are most likely to qualify for a combined marketing and physiological study, a machine learning algorithm applying the criteria of selected pools of all previous marketing and physiological studies may be used to identify qualified individuals.

### Sampling Methods

Methods may include but are not limited to simple random, systematic, stratified random, cluster, and non-probability techniques.

### Communication Methods

These can include but are not limited to email, text messaging, online postings, and automated phone messages.

### Study Specific Screening Tests

Testing which further determines the qualifications of an individual for participation in a specific pool. These instruments and the resultant data can be obtained using local system or remote devices. Tests can include but are not limited to behavioral, psychological, geographical, visual, and physiological testing.

### Example 1

A vision study of color blindness may require individuals who cannot see the colors green and blue. Study specific screening for qualified individuals would include the completion of an online test of color vision.

### Example 2

An fMRI study requiring the completion of a safety survey to determine if it was appropriate for an individual to be exposed to a strong magnetic field.

### Qualification Confirmation

Human individuals who meet necessary study-specific criteria may be contacted with detailed study-specific information and requested to confirm their qualifications and consent. This confirmation is required for inclusion in a human subject pool sample.

### Informed Consent

Acknowledgment by a human individual who agrees to participate in a study and confirms understanding of the purposes, risks, benefits, confidentiality protections, and other relevant aspects of the study.

### Undue Inducement

Refers to personal autonomy of a human in considering alternatives, making choices, and acting without improper influence or interference of others.

### Status Tracking

Refers to information entered by an agent regarding the study participation and compensation status of individuals selected for pool participation. This can include but is not limited to active phase of study participation, scheduling, cancellations, and payment information submitted by a user. Some of this data may be made available to other agents. For example, information indicating whether individuals have consistently arrived on time for other studies may be made available to users who require reliable participants.

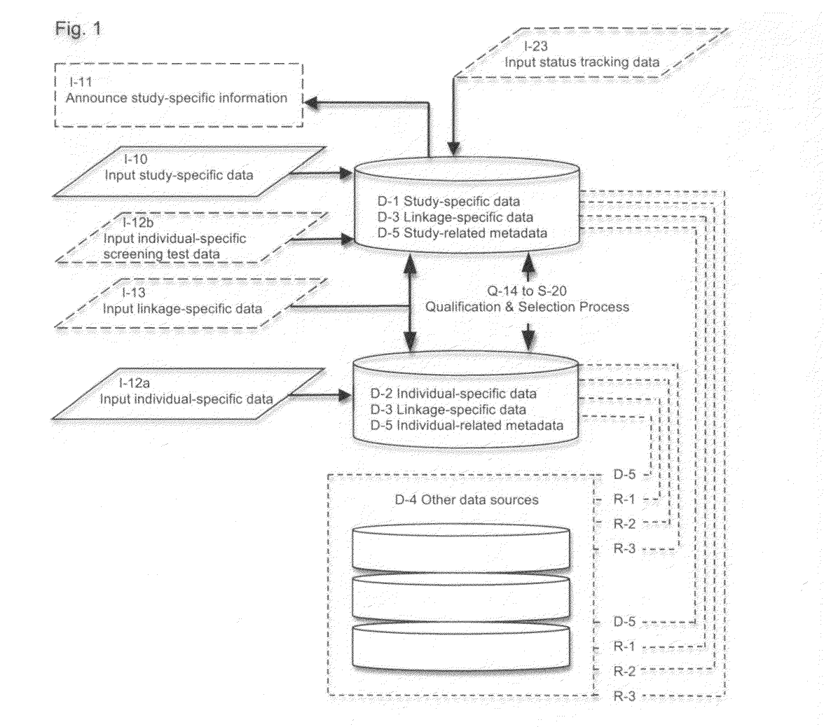

### Description of FIGS. 1-3

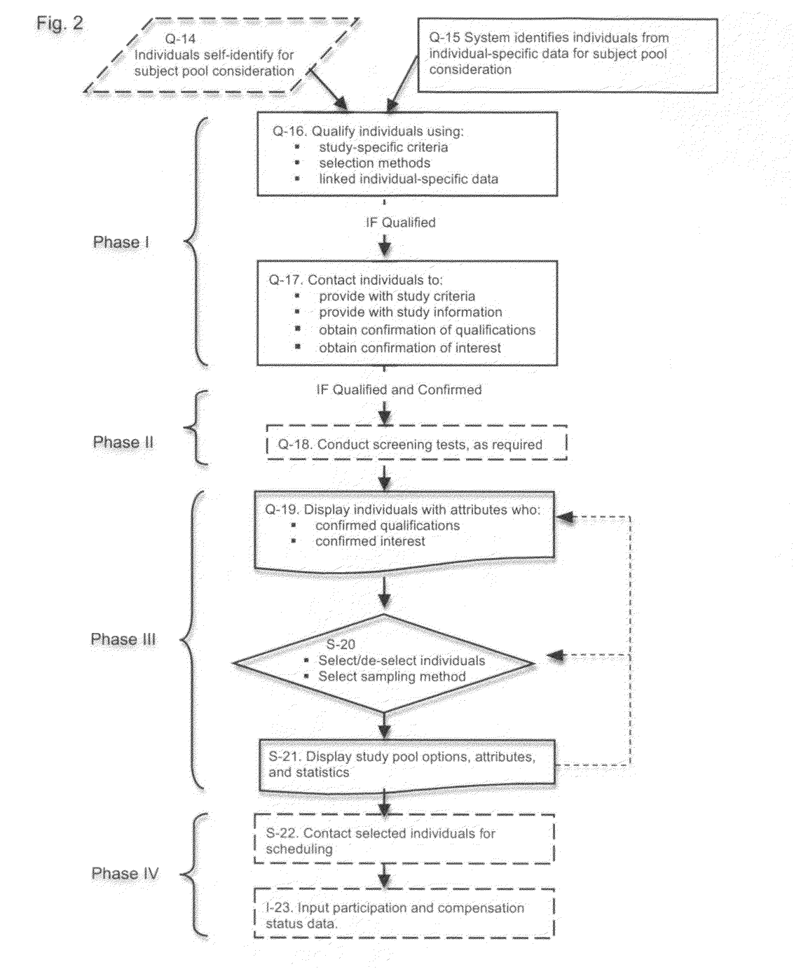

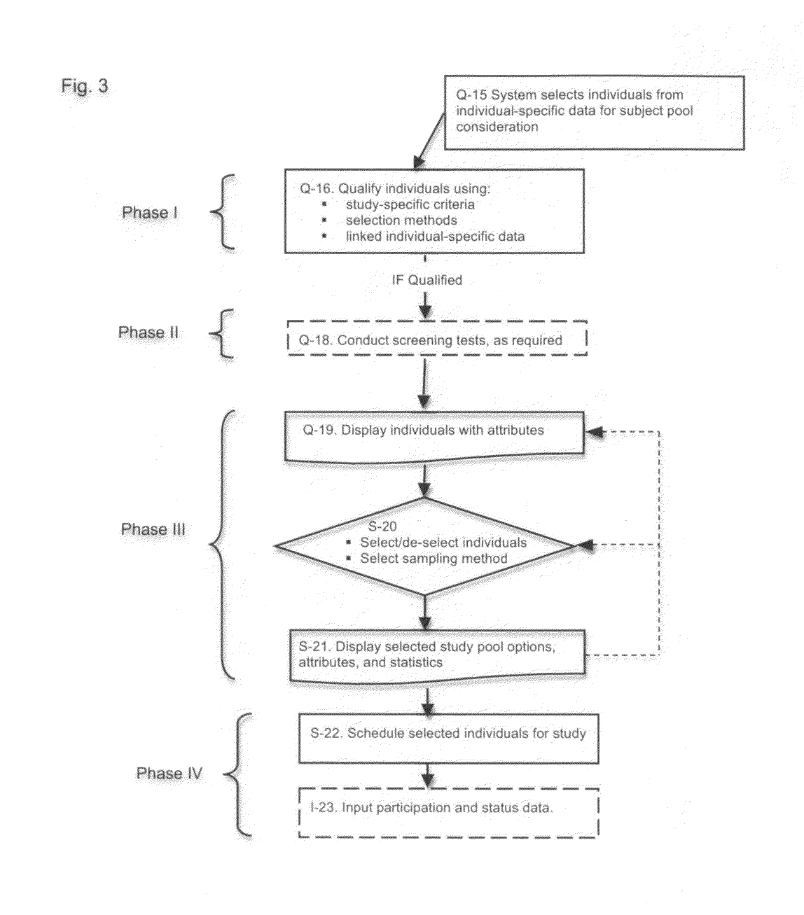

A typical embodiment of the expert system data structure and security is illustrated in FIG. 1. Typical embodiments of system operation are illustrated in FIG. 2 for a human pool and in FIG. 3 for a non-human pool.

Flowchart steps are numbered sequentially. Steps preceded with an I indicates input processes; a Q indicates qualification processes; S indicates selection processes. Dashed lines and object outlines indicate optional processes and data associations.

### FIG. 1 System Data Structure and Security

### System Data Structure Description

Study-specific data (D-1) and metadata (D-5) may be entered into the system and modified either by a user or administrator (I-10). This may be accomplished with a web interface or, as in the case of multiple studies utilizing a standardized protocol, by methods such as bulk uploads, scripted input processes, or other techniques. Study-specific screening test input (I-12b) may optionally be input by an individual.

After a new subject pool description and request is submitted, announcement information is disseminated using communication methods to recruit self-identifying individuals (I-11).

Information generated by the qualification and selection process (Q-14 to S-20) is stored and included as either study- or individual-specific data. Individual data uniquely obtained for a study, such as screening test results, is stored in D-1 with study-specific records. Study data unique to an individual, such as study compensation totals, is stored in D-2 with individual-specific records.

Subsequent to the qualification and selection process, a user may optionally input status tracking information for individuals who have been identified and selected for pool participation (I-23).

Individual-specific data (D-2) may be entered and modified (I-12a) by administrators. In the case of human pools, individuals themselves may input and modify their own personal information.

Linkage-specific data (D-3) may be optionally input either by a user or by an administrator (I-13). This information, can be used for accessing and associating other data (D-4) with study-specific (D-1) or individual-specific data (D-2).

Metadata (D-5) may be obtained directly from a remote source and/or generated by the system using data mining and/or IE methods. Metadata can be used to characterize populations of interest, subject pool selections, or associated with individual-specific or study-specific data records.

Data relationships between individual-specific (D-2), study-specific data (D-1), and other data sources (D-4) can be associated using methods such as unique record or field joins.

### System Data Security Description

System security components are applied according to considerations of data type, source, and agent. The following describes the data security transmission, storage, and access elements of the preferred Internet based system.

All individual-specific and study-specific data entered by individuals (I-12a & I-12b), users (I-10, I-23), and administrators (I-10, I-12a, I-12b, I-13, I-23) is input and accessed into the system data sources (D-1, D-2, D-3) using secure data transmission methods such as secure file transfer protocol (sFTP) and secure socket layer (SSL) encryption methods.

All system data is stored in secure server directories with restricted permissions as appropriate. Methods for ensuring secure information flow, such as taint checking for potentially corrupted data input by malicious users, are incorporated in the overall system. System data access may be protected with methods such as encryption, key coding, and techniques ensuring appropriate k-anonymity levels.

User and administrator access to the system is limited to devices located at authorized locations. These are identified using internet protocol (IP) addresses captured by the system and compared to an approved IP list. In the case of human subject pools, individuals may input and modify personal individual-specific data (D-2) and view study-specific listing data from any IP location unless deemed otherwise by an administrator.

Login and password information is required for all access to system data. Upon submission of a new study (D-1) listing, users obtain a login and password for access to that study record and related information. In the case of human subject pools, upon submission of a new individual (D-2) listing the human agent obtains a login and password to access to that individual record and related study information.

Privacy and confidentiality of sensitive individual-specific information is further supported by restricting the quantity, detail, and access of D-2 data.

Quantity of individual-specific data (D-2) is restricted to minimal common data necessary for the disciplines the system is intended to accommodate. This D-2 data is applied in two ways: to qualify an individual for specific studies and associate individual records with data from other data sources (D-4).

For example, a system supporting the selection of human subject pools for the disciplines of sociology, psychology, neuroscience, and political science may be required. The common individual-specific data used for study qualification may be limited to general information such as gender, birth date, educational attainment, and native language. Data used for association with other data sources may include data such as postal code, email address, IP address, as well as quasi-identifiers composed of any combination of individual-specific data fields.

Details of individual-specific data (D-2) is further restricted by limiting the data to generalized or a subset of the necessary information.

For example, postal code information can be restricted to the collection of annual income bracket rather than actual income; just the first three digits of five digit postal codes; or only the birth year of a birth date.

User access to individual-specific information related to a given study (D-1), such as details associated with other data (D-4), screening tests, and confirmation of qualifications, is restricted in two ways: login with password protection and application of differential privacy methods.

Differential privacy methods formally constrain the disclosure of specific of individual records without precluding the release of data set statistical information. In this system these methods are applied in cases of sensitive information that is required for study specific qualification of individuals, selection of representative subject pools, and identification of pool related sources of variation.

For example, the selection of a representative subject pool of returning war veterans may require statistical information about the proportion of individuals who have or have not sought mental health care. Using differential privacy methods, the necessary information may be extracted from individual screening data without disclosing to users the specifics of individual records.

Email communication is protected by limiting content associated with sensitive information and/or the use of encryption methods.

FIG. 2 System Operation for the Selection of a Human Subject Pool

After new study information is submitted by an agent, either by a user or an administrator, communication methods may be used to convey the relevant information to potential participants. Individuals may then self-identify interest in that study (Q-14).

Alternately, the system may search and identify the individual-specific data (D-2) for potentially qualified individuals given a study criteria.

Next, the data for self- or system-identified individuals is used in the qualification and selection processes.

### Qualification and Selection Process Overview

There are four main qualification and selection phases for assembling representative human subject pools:
Phase I: Individuals are qualified and contacted with study-specific criteria and information
Phase II: Individuals confirm qualifications and interest in pool participation
Phase III: Users make pool sampling and selection choices; repeating if required
Phase IV: Users contact, schedule, and track selected pool members

### Phase I

If specified by an agent, individual-specific data (D-2) and other data (D-4), may be linked and queried. Generally qualified individuals are identified using study-specific selection methods and criteria applied to the linked or unlinked individual-specific data (Q-16).

For example, a study may require a pool consisting of individuals who live in densely populated urban areas. If the individual specific-data does not include this information, it may however contain postal code information. A search of the linkage-specific data (D-3) may identify the location and access information of a data resource that contains population density information associated with postal code areas, such as the US Census. Using this other data (D-4) the system may then identify the postal codes for densely populated urban areas. The individual-specific data can then be searched with the postal codes of these urban areas of interest in order to identify potentially qualified individuals.

Depending on the needs of the study, number of potentially qualified individuals, and expected response rates, sampling methods may be used to select individuals to be contacted.

Communication methods are then used to contact qualified individuals who meet or are adequately likely to meet study-specific criteria with detailed study information. This includes information needed to fulfill the requirements of informed consent and undue inducement. Individuals are then requested to confirm qualifications and interest in study participation using one or more communication methods (Q-17).

### Phase II

Individuals who chose to respond, are qualified, and want to participate in the study may be requested to complete any additional study-specific screening tests (Q-18).

### Phase III

Users are given access to the attributes of qualified and confirmed individuals. These attributes can include but are not limited to individual-specific and associated other data; screening test results; and status tracking data from other studies that qualified individuals may have been previously qualified for or participated in (Q-19).

Users may select or de-select qualified and confirmed individuals to be included in subject pool groups and may choose one or more sampling methods (S-20) to define those groupings. One or more pool groupings from which a user may chose may be displayed along with associated information (S-21). Associated information may include but is not limited to statistics indicating the degree to which a given grouping is representative of the population of interest, summary statistics for the group, estimated statistical power of the grouping for the given study design, and/or specific attributes of individual members in the group. This information may be used to select the preferred subject pool group(s) as well as to identify sources of variation related to the subject pool(s).

A user may repeat steps Q-19, S-20, and S-21 as required.

### Phase IV

Users may employ one or more communication methods to confirm and schedule individuals for study participation (S-22). Users may record tracking data including participation and compensation information (I-23).

FIG. 3 System Operation for the Selection of a Non-Human Subject Pool

After new study information is entered by an agent, a search is made of the individual-specific database (D-2). Individuals identified as adequately likely candidates pass through the qualification and selection process.

### Qualification and Selection Overview

There are four main qualification and selection phases for assembling representative non-human pools:

Phase I: Individuals are qualified using study-specific criteria
Phase II: If required, additional screening tests are performed
Phase III: Users make pool sampling and selection choices; repeating if required
Phase IV: Users schedule and track selected pool members

### Phase I

The individual-specific data (D-2) may be associated with other data (D-4) and queried. Qualified individuals are then identified using study-specific selection methods and criteria (Q-16).

### Phase II

Optional study-specific screening tests are performed to further qualify individuals (Q-18).

### Phase III

Qualified individuals are displayed with attributes that can include but are not limited to individual-specific and associated other data; screening test results; and status tracking data for the given study and other studies (Q-19).

Users may select or de-select qualified individuals to be included in subject pool groups and may choose one or more sampling methods (S-20) to define those groupings. One or more pool groupings from which a user may chose may be displayed along with associated information (S-21).

A user may repeat steps Q-19, S-20, and S-21 as required.

### Phase IV

Users schedule individuals for study participation (S-22) and record participation information (I-23)

In summary, the system provides a highly adaptable, streamlined method for identifying and selecting representative subject pool groups that flexibly meet the requirements of diverse disciplines.

It provides users with access to extensive data from which sources of variation stemming from specific individuals and subject pool composition characteristics can be identified.

The system addresses data security both by incorporating advanced security methods and significantly minimizing the quantity of system specific data required to identify qualified individuals and select optimally representative pool groups.

And in cases where individuals are human, the system further addresses privacy and confidentiality issues by limiting user data access to individuals who have given informed consent for the user's specific study.

While the above description contains many specifics, these should not be construed as limitations on the scope of this invention, but rather as an exemplification of one preferred embodiment thereof. Many other variations are possible.

In addition to the Internet, the system method can also operate on other computing platforms including LANs, WANs, and a stand-alone processors.

While the preferred embodiments describe the selection of representative subject pool groups, group uses may include any recruiting, research, measurement, or optimization activities.

For example, the invention may be applied to the recruitment of an employee pool group chosen to participate together as a project team; a national citizens sample pool chosen for political strategy focus groups; a water system pool used in a statewide test and measurement of overall water quality; or a food product pool utilized for the optimization of a general purpose packaging product.

Accordingly, the scope of this invention should be determined not by the embodiments illustrated, but by the appended claims and their legal equivalents.

What is claimed is:

1. A method for assembling representative groups, said method comprising the steps of:
a) creating a data source consisting of a plurality of individual-specific data and means for creating data associations with a plurality of other data sources;
b) providing a plurality of criteria and selection methods with means for identifying qualified individuals using said data;
c) providing a plurality of sampling methods with means for selecting representative groups comprised of said identified individuals;
whereby one or more qualified individuals may be identified and
whereby said individuals may assembled into representative groups and
whereby said method accommodates group selection criteria of diverse disciplines and
whereby sources of variation pertaining to said groups may be identified.

2. The method of claim 1 further including means for secure transmission, storage, and access of said data comprising encryption, coded data, secure information flow, k-anonymity, multi-level database, restricted access, and differential privacy techniques whereby system data security is supported.

3. The method of claim 1 further including means for characterizing populations and groups whereby distinguishing traits may be identified.

4. The method of claim 1 further including means for conducting screening tests comprising behavioral, geographical, psychological, visual, physiological, and physical evaluations whereby data identifying individual characteristics may be obtained.

5. The method of claim 1 further including means for communicating information whereby individuals may be recruited and appraised of opportunities.

6. The method of claim 1 further including means for tracking and summarizing participation and compensation status of said individuals whereby authorized agents may access and update said status information.

7. A computer program product for assembling representative groups comprising:
a) a computer processor having humanly sensible input and output,
b) a computer-useable storage medium having a computer-readable program code being executable by said computer processor,
c) said computer program arranged to cause said computer processor to create a database consisting of a plurality individual-specific data with means for creating data associations with a plurality of other data sources;
d) said computer program arranged to cause said computer processor to provide a plurality of criteria and selection methods with means for identifying qualified individuals using said data;
e) said computer program arranged to cause said computer processor to provide a plurality of sampling methods with means for selecting representative groups comprised of said identified individuals;
whereby one or more qualified individuals may be identified and
whereby said individuals may assembled into representative groups and
whereby said method accommodates group selection criteria of diverse disciplines and
whereby sources of variation pertaining to said groups may be identified.

8. The computer program of claim 7 further including means for secure transmission, storage, and access of said data comprising encryption, coded data, secure information flow, k-anonymity, multi-level database, restricted access, and differential privacy techniques whereby system data security is supported.

9. The computer program of claim 7 further including means for characterizing populations and groups whereby distinguishing traits may be identified.

10. The computer program of claim 7 further including means for conducting screening tests comprising behavioral, geographical, psychological, visual, physiological, and physical evaluations whereby data identifying individual characteristics may be obtained.

11. The computer program of claim 7 further including means for communicating information whereby individuals may be recruited and appraised of opportunities.

12. The computer program of claim 7 further including means for tracking and summarizing participation and compensation status of said individuals whereby authorized agents may access and update said status information.

13. A method for identifying individuals, said method comprising the steps of:
a) providing means for secure transmission, storage, and access of data;
a) creating a data source consisting of a plurality of individual-specific data and means for creating data associations with a plurality of other data sources;
b) providing a plurality of criteria and selection methods with means for identifying qualified individuals using said data;
whereby data security, confidentiality, and privacy is protected and
whereby one or more qualified individuals may be identified and
whereby said method accommodates selection criteria of diverse disciplines and
whereby sources of variation pertaining to said individuals may be identified.

14. The method of claim 13 further including means for conducting screening tests comprising behavioral, geographical, psychological, visual, physiological, and physical evaluations whereby data identifying individual characteristics may be obtained.

15. The method of claim 13 further including means for communicating information whereby individuals may be recruited and apprised of opportunities.

16. The method of claim 13 further including means for tracking and summarizing participation and compensation status of said individuals whereby authorized agents may access and update said status information.
